(19) United States
(12) Patent Application Publication
(10) Pub. No.: US 2022/0153995 A1
(43) Pub. Date: May 19, 2022

(54) THERMOPLASTIC POLYURETHANE RESIN COMPOSITION AND MOLDED ARTICLE

(71) Applicant: Covestro Intellectual Property GmbH & Co. KG, Leverkusen (DE)

(72) Inventors: Yuichi Nishino, Osaka (JP); Shinji Hayashi, Osaka (JP)

(21) Appl. No.: 17/598,363

(22) PCT Filed: Apr. 6, 2020
(86) PCT No.: PCT/EP2020/059738

§ 371 Date: Sep. 27, 2021

(30) Foreign Application Priority Data
Apr. 8, 2019 (JP) 2019-073412

(51) Int. Cl. C08L 75/08; C08G 18/76; C08G 18/32; C08G 18/48; C08G 18/66

(52) U.S. Cl. CPC C08L 75/08; C08G 18/7671; C08G 18/6674; C08G 18/4854; C08G 18/3206

(57) ABSTRACT

[Problem] To provide a thermoplastic polyurethane resin composition and a molded article that display low hardness and low rebound resilience as well as good moldability.

[Solution] The present invention relates to a thermoplastic polyurethane resin composition containing a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower.

### TECHNICAL FIELD

The present invention relates to a thermoplastic polyurethane resin composition and a molded article.

### BACKGROUND ART

Thermoplastic polyurethane resins (“TPUs”) are an important material in the rapidly growing thermoplastic elastomer field. Thermoplastic polyurethane resins are obtained by polymerizing a polyol and a polyisocyanate in the presence of a chain extender. By adjusting the composition and blend ratio of the above three raw materials, the thermoplastic polyurethane resins can cover a wide hardness range.

Thermoplastic polyurethane resins are therefore used for many purposes, but there also exists a demand for further lowering the hardness with a view toward further improving the soft feel and elasticity and replacing rubber products. However, as the thermoplastic polyurethane resin decreases in hardness, the curing rate when cooled from a molten state decreases and surface tackiness also increases. Therefore, when such resins are used in molding, a drawback is that the moldability deteriorates, as evidenced by deformation of the molded article, a pronounced increase in the cooling time, adhesion of molded articles to each other, or poorer release from the mold in injection molding. Thus, the moldability tends to deteriorate as the hardness decreases.

In addition, depending on the application, there is also a demand to achieve both low hardness and low rebound resilience. However, the rebound resilience of thermoplastic polyurethane resins tends to rise as the hardness decreases.

Thus, it is difficult to provide thermoplastic polyurethane resins that display low hardness and low rebound resilience as well as good moldability since low rebound resilience and moldability are each in a contradictory relationship with low hardness. For example, Patent Reference 1 discloses that both low hardness and moldability can be achieved by using a specific thermoplastic polyurethane resin together with a hydrogenated product of a specific random copolymer. There remains room for improvement, however, as far as providing a thermoplastic polyurethane resin composition that displays low hardness and low rebound resilience as well as good moldability.

### PRIOR ART REFERENCES

### Patent References

Patent Reference 1: JP Kokai Hei 06-145502

### SUMMARY OF THE INVENTION

### Problems to be Solved by the Invention

The present invention overcomes the above problem, it being an object thereof to provide a thermoplastic polyurethane resin composition and a molded article that display low hardness and low rebound resilience as well as good moldability.

### Means Used to Solve the Above-Mentioned Problems

As a result of thoroughgoing studies, the inventors accomplished the present invention upon finding out that a thermoplastic polyurethane resin composition that displays low hardness and low rebound resilience as well as good moldability can be provided by using a thermoplastic polyurethane resin in combination with a specific hydrogenated aromatic vinyl-based elastomer.

Specifically, the present invention relates to a thermoplastic polyurethane resin composition containing a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower.

The hydrogenated aromatic vinyl-based elastomer is preferably an elastomer obtained by hydrogenating a polymer composed of a polymer block made mainly of an aromatic vinyl compound and a random copolymer block of an aromatic vinyl compound and a conjugated diene compound.

The thermoplastic polyurethane resin composition preferably has a Shore A hardness of 90 or lower, a rebound resilience of 55% or lower, and a Taber abrasion of 400 mg or lower.

The mass ratio of the thermoplastic polyurethane resin and the hydrogenated aromatic vinyl-based elastomer (thermoplastic polyurethane resin/hydrogenated aromatic vinyl-based elastomer) is preferably from 99/1 to 55/45.

The Shore A hardness of the thermoplastic polyurethane resin is preferably 90 or lower.

The thermoplastic polyurethane resin is preferably a polyether-based thermoplastic polyurethane resin.

The present invention also relates to a molded article obtained by molding the resin composition.

### Advantages of the Invention

The thermoplastic polyurethane resin composition of the present invention displays low hardness and low rebound resilience as well as good moldability due to containing a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower.

### MODE FOR CARRYING OUT THE INVENTION

The thermoplastic polyurethane resin composition of the present invention contains a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower. The composition therefore displays low hardness and low rebound resilience as well as good moldability (especially injection moldability).

The abovementioned effects are obtained using the resin composition. The reason that such actions and effects are obtained is not necessarily clear but is assumed to be as follows.

The aromatic vinyl-based elastomer has blocks made of an aromatic vinyl compound component as hard segments at both ends and a block made of a conjugated diene compound component as a soft segment in the middle, as typified by SEBS and the like. The hardness of an aromatic vinyl-based elastomer generally declines as the amount of aromatic vinyl that serves as the hard segment decreases, but the rebound resilience rises as the soft segment component increases (tendency to be inversely proportional). Polymers that randomly incorporate an aromatic vinyl-based component in addition to a conjugated diene compound component in the middle block have also been studied in recent years. The rebound resilience decreases without any appreciable rise in hardness when an aromatic vinyl component is randomly incorporated into the soft component of the middle block.

Therefore, it is assumed that an aromatic vinyl-based elastomer having low hardness and low resilience can be prepared by adjusting the amount of aromatic vinyl-based high-Tg component incorporated into each of the hard segment and soft segment. Specifically, in the case of common SEBS, with respect to the hardness and rebound resilience which are in an inversely proportional relationship, performing the above adjustment makes it possible to keep the product of the two values to 1300 or lower, and to make the Shore A hardness 90 or lower and the rebound resilience 20% or lower. As a result, both lowering of the hardness and lowering of the resilience of the aromatic vinyl-based elastomer itself can be achieved, which was difficult to attain in the past. Therefore, the thermoplastic polyurethane resin composition ultimately obtained also achieves low resilience and lowering of the hardness as well as good moldability. Furthermore, performing the above adjustment also has the effect of improving the compatibility of the aromatic vinyl-based elastomer with the thermoplastic polyurethane resin, and the wear resistance also improves while satisfying the above three types of performance.

### Thermoplastic Polyurethane Resin

Next, the thermoplastic polyurethane resin will be described.

There are no particular limitations as to which thermoplastic polyurethane resins can be used.

In the present specification, a thermoplastic polyurethane resin is a resin (elastomer) obtained by polymerizing a polyol and a polyisocyanate in the presence of a chain extender.

There are no particular limitations as to the polyol; any conventional, known polyols can be used.

Examples of polyols include polymeric polyols such as polyester-based polyols, polyether-based polyols, polycarbonate-based polyols, polylactone-based polyols, and the like. These polyols may be used alone or in combinations of two or more.

The average molecular weight (number average molecular weight) of the polyol is preferably 500 or higher, more preferably 700 or higher, and even more preferably 900 or higher. The average molecular weight of the polyol is preferably 5000 or lower, more preferably 4000 or lower, even more preferably 3000 or lower, especially preferably 2500 or lower, most preferably 2300 or lower, and ideally 2100 or lower. Effects are obtained more suitably within the above range.

In the present specification, the average molecular weight of the polyol is the value calculated from the hydroxyl value obtained by measurement in accordance with JIS K1557-1 (2007) and the acid value obtained by measurement in accordance with JIS K1557-5 (2007).

Polyester-based polyols are not particularly restricted as long as the polyester-based polyol is a condensation product of a polyvalent carboxylic acid or a reactive derivative thereof and a polyhydric alcohol. Examples thereof include those obtained by condensation polymerization of dicarboxylic acids and glycols.

Examples of dicarboxylic acids include succinic acid, glutaric acid, adipic acid, azelaic acid, sebacic acid, dodecanedicarboxylic acid, fumaric acid, maleic acid, and other such aliphatic dicarboxylic acids; orthophthalic acid, terephthalic acid, isophthalic acid, 2,6-naphthalenedicarboxylic acid, and other such aromatic dicarboxylic acids; and reactive derivatives thereof; 1,3-cyclopentanedicarboxylic acid, 1,2-cyclohexanedicarboxylic acid, 1,3 -cyclohexanedicarboxylic acid 1,4-cyclohexanedicarboxylic acid, and other such alicyclic dicarboxylic acids, etc. These dicarboxylic acids may be used alone or in combinations of two or more. Among them, adipic acid is preferred.

Examples of glycols include dimethylene glycol, ethylene glycol, diethylene glycol, triethylene glycol, tetraethylene glycol, propylene glycol, dipropylene glycol, tripropylene glycol, 1,3-propanediol, neopentyl glycol, 2,2-diethyl-1,3-propanediol, butylethyl propanediol, 1,2-butanediol, butylene glycol, 1,4-butanediol, dimethyl butanediol, 1,5-pentanediol, 2,4-diethyl pentanediol, 1,6-hexanediol, 3-methyl 1,5-pentanediol, 1,8-octanediol, 1,9-nonanediol, 1,10-decanediol, 1,12-dodecanediol, polyethylenebutylene glycol, and other such aliphatic glycols; 1,3-cyclopentanediol, 1,4-cyclohexanediol, 1,4-cyclohexanedimethanol, 2,2-bis(4-hydroxycyclohexyl)propane, and other such alicyclic glycols; m-xylylene glycol, p-xylylene glycol, bisphenol A, bisphenol F, bisphenol S, and other such aromatic glycols. These glycols may be used alone or in combinations of two or more. Among them, aliphatic glycols are preferred, and polyethylenebutylene glycol is more preferred.

Examples of polyester-based polyols include polyethylene adipate glycol, polybutylene adipate glycol, polyhexamethylene adipate glycol, polyethylenebutylene adipate glycol, and other such condensed polyester polyols.

Examples of polyether-based polyols include polytetramethylene glycol, polyoctylene glycol, polypropylene glycol, and other such aliphatic polyether polyols.

Examples of polycarbonate-based polyols include polyols obtained by a dealcoholation reaction of ethylene glycol, propylene glycol, butanediol, pentanediol, hexanediol, octanediol, nonanediol, 1,4-cyclohexanedimethanol, or another such low-molecular polyol and diethylene carbonate, dipropylene carbonate, diphenyl carbonate, or another such carbonate compound.

Examples of polylactone-based polyols include polylactonediol, polycaprolactonediol, polymethylvalerolactonediol, and other such lactone-based polyester diols obtained by ring-opening polymerization of a lactone using the above low-molecular polyols or the like as an initiator.

Polyester-based polyols and polyether-based polyols are preferred as polyols; polyether-based polyols are more preferred, polytetramethylene glycol, polyethylene glycol, and polypropylene glycol are even more preferred, and polytetramethylene glycol is especially preferred. The effects of the present invention are obtained especially suitably when the thermoplastic polyurethane resin is a polyether-based thermoplastic polyurethane resin that uses a polyether-based polyol as the polyol.

The polyisocyanate is not particularly restricted as long as the polyisocyanate has two or more isocyanate groups, and conventional, known polyisocyanates can be used.

Examples of diisocyanates having two isocyanate groups include 1,6-hexamethylene diisocyanate (HDI), 2,2,4-trimethylhexamethylene diisocyanate, methylene diisocyanate, isopropylene diisocyanate, lysine diisocyanate, lysine diisocyanate methyl ester, 1,5-octylene diisocyanate, and other such aliphatic isocyanates; 4,4′-dicyclohexylmethane diisocyanate, isophorone diisocyanate (IPDI), norbornene diisocyanate, hydrogenated tolylene diisocyanate, methylcyclohexane diisocyanate, isopropylidene bis(4-cyclohexylisocyanate), dimer acid diisocyanate, and other such alicyclic isocyanates; 2,4- or 2,6-tolylene diisocyanate (TDI), 4,4′-diphenylmethane diisocyanate (MDI), 1,5-naphthalene diisocyanate, p- or m-xylylene diisocyanate (XDI), tolidine diisocyanate, p-phenylene diisocyanate, diphenyl ether diisocyanate, diphenyl sulfone diisocyanate, dianisidine diisocyanate, tetramethyl-m-xylylene diisocyanate, and other such aromatic isocyanates.

Examples of polyisocyanates having three or more isocyanate groups include triphenylmethane triisocyanate, triisocyanate phenylthiophosphate, polymethylene polyphenylene polyisocyanate (polymeric MDI), an isocyanurate modified product which is a trimer of HDI or TDI, a biuret modified product, etc.

These polyisocyanates may be used alone or in combinations of two or more. Among them, diisocyanates having two isocyanate groups are preferred, aromatic diisocyanates are more preferred, and 4,4-diphenylmethane diisocyanate (MDI) is even more preferred as the polyisocyanate. 1,6-Hexamethylene diisocyanate (HDI), 4,4-dicyclohexylmethane diisocyanate, etc., can also be used when imparting functionality such as discoloration resistance.

The chain extender is not particularly restricted, and conventional, known chain extenders can be used.

Conventional, known polyhydric alcohols and amines can all be used as chain extenders, but low-molecular polyols having 2 to 10 carbon atoms are preferred.

Examples of low-molecular polyols include ethylene glycol, diethylene glycol, propylene glycol, dipropylene glycol, 1,3-butanediol, 1,4-butanediol, 2-methylpentanediol, 1,5-pentanediol, 1,6-hexanediol, neopentyl glycol, octanediol, nonanediol, decanediol, trimethylpropane, glycerin, and other such aliphatic polyols; cyclohexanediol, cyclohexanedimethanol, and other such alicyclic polyols; bishydroxyethoxybenzene, xylene glycol, and other such aromatic polyols; etc. These chain extenders may be used alone or in combinations of two or more. Among them, aliphatic polyols are preferred and 1,4-butanediol is more preferred as the chain extender.

The thermoplastic polyurethane resin used in the present invention can be produced, in the same way as ordinary polyurethane resins, by the so-called prepolymer method in which the polyol, polyisocyanate, and chain extender described above are reacted, for example, by reacting an isocyanate group-terminated prepolymer obtained by reacting the polyol and the polyisocyanate in advance, with the chain extender, or the so-called one-shot method in which the polyol and chain extender are premixed and this mixture is then reacted with the polyisocyanate. The equivalent ratio ([NCO]/[OH]) of the total number of moles of isocyanate groups to the total number of moles of active hydrogen groups in all raw materials is preferably adjusted to 0.8-1.2, more preferably 0.9-1.1, to adjust the properties (hardness, rebound resilience, etc.) of the thermoplastic polyurethane resin to a suitable range.

The Shore A hardness of the thermoplastic polyurethane resin is preferably 90 or lower, more preferably 88 or lower, even more preferably 86 or lower. The lower limit is not particularly restricted, but is preferably 60 or higher, and more preferably 70 or higher. Effects are obtained more suitably within this range.

Furthermore, in the present specification, the hardness of the thermoplastic polyurethane resin, hydrogenated aromatic vinyl-based elastomer, and thermoplastic polyurethane resin composition is the value measured at 25° C. in accordance with JIS K7311 (1995).

The rebound resilience of the thermoplastic polyurethane resin is preferably lower as long as the hardness and moldability are balanced. The rebound resilience is preferably 70% or lower, more preferably 66% or lower, even more preferably 60% or lower, especially preferably 55% or lower, and most preferably 45% or lower. The lower limit is not particularly restricted but is preferably 10% or higher, more preferably 20% or higher, even more preferably 30% or higher. Effects are obtained suitably within this range.

Furthermore, in the present specification, the rebound resilience of the thermoplastic polyurethane resin, hydrogenated aromatic vinyl-based elastomer, and thermoplastic polyurethane resin composition is the value measured at 25° C. in accordance with JIS K7311 (1995).

Adjusting the properties (hardness, rebound resilience, etc.) of the thermoplastic polyurethane resin to the above suitable ranges is easy for one skilled in the art, and the suitable embodiments described above, for example, may be adopted. Commercial products may also be used.

Examples of methods for adjusting the properties (hardness, rebound resilience, etc.) of the thermoplastic polyurethane resin to the above suitable ranges include a method which uses a polyol having an average molecular weight within the above preferred numerical value range as a polyol, a method which uses a polyether-based polyol (preferably polytetramethylene glycol) as a polyol, a method which uses an aromatic diisocyanate (preferably 4,4′-diphenylmethane diisocyanate (MDI)) as a polyisocyanate, a method which uses an aliphatic polyol (preferably 1,4-butanediol) as a chain extender, and a method which adjusts the equivalent ratio of the total number of moles of isocyanate groups to the total number of moles of active hydrogen groups in all raw materials to 0.8-1.2.

### Hydrogenated Aromatic Vinyl-Based Elastomer Having a Shore A Hardness of 90 or Lower, a Rebound Resilience of 1-20%, and a Product of the Shore A Hardness and Rebound Resilience of 1300% or Lower

The hydrogenated aromatic vinyl-based elastomer will be described next.

Useable hydrogenated aromatic vinyl-based elastomers are not particularly restricted as long as the hydrogenated aromatic vinyl-based elastomer has a Shore A hardness of 90 or lower, a rebound resilience of 1-20%, and a product of the Shore A hardness and rebound resilience of 1300% or lower.

In the present specification, the hydrogenated aromatic vinyl-based elastomer is an elastomer (resin) in which hydrogenation treatment has been carried out on an elastomer having a unit derived from an aromatic vinyl compound as a structural unit (preferably an elastomer having units derived from an aromatic vinyl compound and a conjugated diene compound as structural units). More preferably, the hydrogenated aromatic vinyl-based elastomer is an elastomer (resin) in which hydrogenation treatment has been carried out on an elastomer having a block with a unit derived from an aromatic vinyl compound as a structural unit (preferably an elastomer having a block with a unit derived from an aromatic vinyl compound as a structural unit and a block with a unit derived from a conjugated diene compound as a structural unit).

An elastomer obtained by hydrogenating a polymer comprising a polymer block composed mainly of an aromatic vinyl compound and a random copolymer block of an aromatic vinyl compound and a conjugated diene compound is preferred as the hydrogenated aromatic vinyl-based elastomer; an elastomer obtained by hydrogenating a polymer comprising a polymer block composed mainly of styrene and a random copolymer block of styrene and butadiene is more preferred; an elastomer obtained by hydrogenating a polymer having polymer blocks composed mainly of styrene at both ends and a random copolymer block in the middle, comprising a polymer block composed mainly of styrene and a random copolymer block of styrene and butadiene, is even more preferred; and an elastomer obtained by hydrogenating a polymer having polymer blocks composed of styrene at both ends and a random copolymer block in the middle, comprising a polymer block composed of styrene and a random copolymer block of styrene and butadiene, is especially preferred.

Using a copolymer having this structure is believed to lower both hardness and resilience, to reduce tack because of the rapid solidification rate after molding, and to be able to minimize any deterioration in properties due to blending because of the excellent compatibility with the thermoplastic polyurethane resin.

Here, the unit derived from a conjugated diene compound; for example, a unit derived from butadiene, is subjected to hydrogenation treatment to form an ethylene unit or a butylene unit. For example, subjecting a styrene-butadiene-styrene block copolymer (SBS) to hydrogenation treatment forms a styrene-ethylene/butylene-styrene block copolymer (SEBS).

In the present specification, the polymer block composed mainly of an aromatic vinyl compound has an aromatic vinyl compound content (content of units derived from aromatic vinyl compound) in the polymer block preferably of 50 mass % or higher, more preferably 60 mass % or higher, even more preferably 70 mass % or higher, especially preferably 80 mass % or higher, most preferably 90 mass % or higher, even more most preferably 95 mass % or higher, and even more most preferably 98 mass % or higher; and the content may be 100 mass %.

Similarly, in the present specification, the polymer block composed mainly of styrene preferably has a styrene content in the polymer block of 50 mass % or higher, more preferably 60 mass % or higher, even more preferably 70 mass % or higher, especially preferably 80 mass % or higher, most preferably 90 mass % or higher, even more most preferably 95 mass % or higher, and even more most preferably 98 mass % or higher; and the content may be 100 mass %.

Examples of the aromatic vinyl compound include styrene, α-methylstyrene, p-methylstyrene, divinyl benzene, 1,1-diphenylethylene, N,N-dimethyl-p-aminoethyl styrene, N,N-diethyl-p-aminoethyl styrene, etc. These compounds may be used alone or in combinations of two or more. Among them, styrene is preferred. Specifically, the hydrogenated aromatic vinyl-based elastomer is preferably a hydrogenated styrene-based elastomer.

Examples of the conjugated diene compound include butadiene, isoprene, 2,3-dimethyl-1,3-butadiene, 1,3-pentadiene, 2-methyl-1,3-pentadiene, 1,3-hexadiene, etc. These compounds may be used alone or in combinations of two or more. Among them, butadiene and isoprene are preferred, and butadiene is more preferred.

Concrete examples of the hydrogenated aromatic vinyl-based elastomer include styrene-ethylene/butylene-styrene block copolymer (SEBS), styrene-isobutylene-styrene block copolymer (SIBS), styrene-isoprene-styrene block copolymer (SIS), styrene-isobutylene block copolymer (SIB), styrene-ethylene/propylene-styrene block copolymer (SEPS), styrene-ethylene/ethylene/propylene-styrene block copolymer (SEEPS), styrene-butadiene/butylene-styrene block copolymer (SBBS), styrene-ethylene-propylene block copolymer (SEP), etc.

Also, other examples are copolymers in which the styrene in the above copolymers has been replaced by α-methylstyrene, p-methylstyrene, divinyl benzene, 1,1-diphenyl ethylene, N,N-dimethyl-p-aminoethyl styrene, or N,N-diethyl-p-aminoethyl styrene.

In addition, other examples are copolymers in which the conjugated diene compound such as butadiene or isoprene in the above copolymers has been replaced by 2,3-dimethyl-1,3-butadiene, 1,3-pentadiene, 2-methyl-1,3-pentadiene, or 1,3-hexadiene.

These copolymers may be used alone or in combinations of two or more. Among them, SEBS and SIBS are preferred, and SEBS is more preferred.

The Shore A hardness of the hydrogenated aromatic vinyl-based elastomer is 90 or lower, preferably 87 or lower, more preferably 84 or lower; the lower limit is not particularly restricted but is preferably 30 or higher, more preferably 40 or higher, even more preferably 45 or higher, especially preferably 50 or higher, and most preferably 55 or higher. Effects are obtained more suitably within this range.

The rebound resilience of the hydrogenated aromatic vinyl-based elastomer is 20% or lower, preferably 17% or lower, more preferably 14% or lower; the lower limit is not particularly restricted but is preferably 1% or higher, preferably 2% or higher, more preferably 3% or higher, even more preferably 5% or higher, especially preferably 8% or higher, and most preferably 10% or higher. Effects are obtained more suitably within this range.

The product of the Shore A hardness and rebound resilience (Shore A hardness×rebound resilience) of the hydrogenated aromatic vinyl-based elastomer is 1300% or lower, preferably 1250% or lower, more preferably 1200% or lower, even more preferably 1150% or lower, and especially preferably 1100% or lower; the lower limit is not particularly restricted but is preferably 100% or higher, more preferably 200% or higher, even more preferably 300% or higher, especially preferably 400% or higher, most preferably 500% or higher, even more most preferably 600% or higher, and even more most preferably 700% or higher. Effects are obtained more suitably within this range.

The amount of units derived from aromatic vinyl compounds (aromatic vinyl compound content, preferably styrene content) in the hydrogenated aromatic vinyl-based elastomer is preferably 5 mass % or higher, more preferably 10 mass % or higher, even more preferably 15 mass % or higher, preferably 80 mass % or lower, more preferably 70 mass % or lower, and even more preferably 65 mass % or lower. Effects are obtained more suitably within this range.

In the present specification, the content of units derived from aromatic vinyl compounds (preferably styrene content) is the value calculated by ¹H-NMR measurement.

The suitable embodiments described above, for example, may be adopted as methods of adjusting the properties (hardness, rebound resilience, etc.) of the hydrogenated aromatic vinyl-based elastomer to the suitable ranges. Also, commercial products may be used.

Styrene-ethylene/butylene-styrene block copolymer (SEBS) can be given as an example of an elastomer commonly used as a hydrogenated aromatic vinyl-based elastomer in the past. Examples of SEBS copolymers include those having a structure of styrene blocks at both ends and an ethylene/butylene block in the center (middle). However, such SEBS copolymers often do not have the above specific properties. By contrast, SEBS copolymers having a structure of styrene blocks at both ends and a random block of styrene and ethylene butylene in the center have the above specific properties and obtains the effects of the present invention more suitably.

Thus, when the hydrogenated aromatic vinyl-based elastomer has a structure of styrene blocks at both ends and a random block (preferably a random block structure containing styrene) in the center, the elastomer has the above specific properties and the effects of the present invention are obtained more suitably. However, the effects of the present invention are obtained especially suitably in the case of SEBS having styrene blocks at both ends and a random block of styrene and ethylene butylene in the center.

With regard to this point, as a result of thoroughgoing studies, aromatic vinyl-based elastomers, as typified by SEBS and the like, generally have blocks comprising an aromatic vinyl compound component as a hard segment at both ends and a block comprising a conjugated diene compound component as a soft segment in the middle. Also, polymers that randomly incorporate an aromatic vinyl-based component in addition to a conjugated diene compound component in the middle block have been studied in recent years. The hardness of an aromatic vinyl-based elastomer generally decreases as the amount of aromatic vinyl that serves as the hard segment declines, but the rebound resilience rises due to the increase in the soft segment component. By contrast, when an aromatic vinyl component is incorporated randomly into the soft component of the middle block, the rebound resilience decreases with little rise in the hardness. Similar effects are also obtained by using a conjugated diene compound that exhibits high Tg instead of an aromatic vinyl compound randomly incorporated into the middle block. Therefore, it is assumed that an aromatic vinyl-based elastomer of low hardness and low resilience can be prepared by adjusting the amounts of aromatic vinyl-based high-Tg component incorporated into each of the hard segment and soft segment.

In addition, as a result of thoroughgoing studies, it was established that the above specific properties are provided and also the effects of the present invention are obtained more suitably when the hydrogenated aromatic vinyl-based elastomer is an elastomer obtained by hydrogenating a polymer comprising a polymer block composed mainly of an aromatic vinyl compound and a random copolymer block of an aromatic vinyl compound and a conjugated diene compound, more preferably an elastomer obtained by hydrogenating a polymer comprising a polymer block composed mainly of styrene and a random copolymer block of styrene and butadiene, even more preferably an elastomer obtained by hydrogenating a polymer having a polymer block composed mainly of styrene at both ends and a random copolymer block in the middle, comprising a polymer block composed mainly of styrene and a random copolymer block of styrene and butadiene, especially preferably an elastomer obtained by hydrogenating a polymer having a polymer block composed of styrene at both ends and a random copolymer block in the middle, comprising a polymer block composed of styrene and a random copolymer block of styrene and butadiene.

The presence of a unit derived from an aromatic vinyl compound in the random copolymer block which is the soft segment is assumed to improve the compatibility with the thermoplastic polyurethane resin, to lower the hardness and lower the rebound resilience without harming the properties of the thermoplastic polyurethane resin, and even to improve the moldability.

### Thermoplastic Polyurethane Resin Composition

The thermoplastic polyurethane resin composition contains a thermoplastic polyurethane resin and a hydrogenated aromatic vinyl-based elastomer described above.

In the thermoplastic polyurethane resin composition, the mass ratio of the thermoplastic polyurethane resin and hydrogenated aromatic vinyl-based elastomer (thermoplastic polyurethane resin content/ hydrogenated aromatic vinyl-based elastomer content) is preferably 99/1 or higher, more preferably 95/5 or higher, even more preferably 90/10 or higher, especially preferably 85/15 or higher, most preferably 80/20 or higher, even more most preferably 75/25 or higher, and most preferably 70/30 or higher, preferably 55/45 or lower, more preferably 60/40 or lower, and even more preferably 65/35 or lower. Effects are obtained more suitably within this range. Good wear resistance and scratch resistance are also obtained.

The thermoplastic polyurethane resin content in 100 mass % of the thermoplastic polyurethane resin composition is preferably 99 mass % or lower, more preferably 95 mass % or lower, even more preferably 90 mass % or lower, especially preferably 85 mass % or lower, most preferably 80 mass % or lower, even more most preferably 75 mass % or lower, and even more most preferably 70 mass % or lower, preferably 55 mass % or higher, more preferably 60 mass % or higher, and even more preferably 65 mass % or higher. Effects are obtained more suitably within this range. Good wear resistance and scratch resistance are also obtained.

The hydrogenated aromatic vinyl-based elastomer content in 100 mass % of the thermoplastic polyurethane resin composition is preferably 1 mass % or higher, more preferably 5 mass % or higher, even more preferably 10 mass % or higher, especially preferably 15 mass % or higher, most preferably 20 mass % or higher, even more most preferably 25 mass % or higher, and even more most preferably 30 mass % or higher, preferably 45 mass % or lower, more preferably 40 mass % or lower, and even more preferably 35 mass % or lower.

Effects are obtained more suitably within this range. Good wear resistance and scratch resistance are also obtained.

The total content of thermoplastic polyurethane resin and hydrogenated aromatic vinyl-based elastomer in 100 mass % of the thermoplastic polyurethane resin composition is preferably 50 mass % or higher, more preferably 70 mass % or higher, even more preferably 90 mass % or higher, especially preferably 95 mass % or higher, most preferably 98 mass % or higher, and may be 100 mass %. Effects are obtained more suitably within this range. Good wear resistance and scratch resistance are also obtained.

Known additives such as silane coupling agents, fillers, thixotropic agents, tackifiers, waxes, plasticizers, thermostabilizers, antioxidants, UV absorbers, light resistance stabilizers, fillers, fibrous reinforcing materials, pigments, fluorescent whiteners, foaming agents, thermoplastic resins other than the hydrogenated aromatic vinyl-based elastomer, thermosetting resins, dyes, conductivity imparting agents, antistatic agents, moisture permeability improvers, water repellents, oil repellents, hollow foams, water of crystallization-containing compounds, flame retardants, water absorbents, moisture absorbents, deodorants, antibacterial agents, antifungal agents, antiblocking agents, hydrolysis inhibitors, organic water-soluble compounds, and inorganic water-soluble compounds may be blended into the thermoplastic polyurethane resin composition as needed.

The Shore A hardness of the thermoplastic polyurethane resin composition is preferably 90 or lower, more preferably 85 or lower, and even more preferably 83 or lower; the lower limit is not particularly restricted but is preferably 60 or higher, more preferably 65 or higher, even more preferably 70 or higher, and especially preferably 75 or higher. Effects are obtained more suitably within this range.

The rebound resilience of the thermoplastic polyurethane resin composition is preferably 55% or lower, more preferably 50% or lower, even more preferably 45% or lower, especially preferably 40% or lower, and most preferably 35% or lower; the lower limit is not particularly restricted but is preferably 10% or higher, more preferably 20% or higher. Effects are obtained more suitably within this range.

The Taber abrasion of the thermoplastic polyurethane resin composition is preferably 400 mg or less, more preferably 350 mg or less, and even more preferably 300 mg or less; the lower limit is not particularly restricted. A lower Taber abrasion means better wear resistance.

Furthermore, in the present specification, the Taber abrasion of the thermoplastic polyurethane resin composition is the value measured at 25° C. in accordance with JIS K7311 (1995).

The suitable embodiments described above, for example, may be adopted as methods of adjusting the properties (hardness, rebound resilience, etc.) of the thermoplastic polyurethane resin composition to the suitable ranges. Specifically, a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower may be used in combination.

The method for producing the thermoplastic polyurethane resin composition is not particularly restricted. For example, the thermoplastic polyurethane resin composition can be prepared by mixing a thermoplastic polyurethane resin and a hydrogenated aromatic vinyl-based elastomer described above using a kneader, Henschel mixer, etc., feeding the resulting mixture to an extruder, performing melt-kneading at a temperature used to extrude ordinary TPU (approximately 150-250° C.), and then forming pellets by strand cutting or cutting in water.

Commonly used TPU molding methods can be applied as the method for molding the thermoplastic polyurethane resin composition. For example, molding methods such as extrusion molding, injection molding, inflation molding, blow molding, vacuum molding, centrifugal molding, rotational molding, calendering, roll processing, and press processing can be used, and molded articles of various shapes such as resin plates, films, sheets, and differently-shaped products can be produced.

### Molded Article

The thermoplastic polyurethane resin composition described above can be suitably used to fashion a variety of molded articles (molded articles obtained by molding the resin composition).

Examples of molded articles include belts, tubes, hoses, electrical wire coating materials, cable coating materials, fire hoses, gears, casters, packings, wind turbines for wind power generation, and other such machine industry parts; bumpers, side moldings, tail lamp seals, snow chains, ball joint seals, constant velocity joint boots, bellows, spring cover materials, ABS cables, ABS cable plugs, instrument panel skins, gear knobs, console boxes, door seal covers, seat materials, knobs, and other such automotive parts; various types of sheets, air mats, synthetic leather, protective films, and other such films and sheets; shoe soles, watch bands, camera grips, animal ear tags, smart phone cases, tablet cases, keyboard protection covers, ornaments, and other such daily necessities; heart valves, bypass devices, artificial ventricles, dialysis tubes, thin films, connectors, catheters, medical tubes, pacemaker insulators, and other such medical products; interior and exterior materials and other such building materials; skis, rackets, and other such sports equipment; etc. These molded articles can be used in a wide range of indoor and outdoor fields.

### EXAMPLES

The present invention is described concretely based on examples, but the present invention is not restricted to these examples.

The various chemicals used are described in brief below.

Polytetramethylene glycol 1: PTMG 2000 manufactured by Mitsubishi Chemical Corporation (average molecular weight 1900-2100)

Polytetramethylene glycol 2: PTMG 1000 manufactured by Mitsubishi Chemical Corporation (average molecular weight 900-1100)

Polyethylenebutylene adipate glycol (EG/BG-AA hereinafter): Polylite OD-X-2330 manufactured by DIC (average molecular weight 1900-2100)

1,4-Butanediol: 1.4BG manufactured by Mitsubishi Chemical Corporation

4,4′-Diphenylmethane diisocyanate (MDI hereinafter): Sumidur 44S manufactured by Sumika Covestro Urethane Co., Ltd.

### Production Example 1

### Preparation of Thermoplastic Polyurethane Resin

Polyether-based polyol and 1,4-butanediol were mixed according to the formulation shown in Table 1 and reacted for 10 minutes at 160° C. after adding MDI and mixing thoroughly by high-speed stirring. The reaction product was crushed and melt-kneaded using a 40-mm-diameter short-shaft extruder (set temperature 150-250° C.), and made into pellets, resulting in a thermoplastic polyurethane resin (TPU1).

### Production Example 2

A thermoplastic polyurethane resin (TPU2) was obtained according to the formulation shown in Table 1 through the same steps as in Production Example 1.

### Production Example 3

A thermoplastic polyurethane resin (TPU3) was obtained according to the formulation shown in Table 1 through the same steps as in Production Example 1.

2-mm-thick sheets were produced by injection molding using the thermoplastic polyurethane resins (TPU1-3) obtained, and the following evaluations were performed. The respective test results are shown in Table 1.

### Hardness

The hardness of the thermoplastic polyurethane resin obtained was measured at 25° C. using a type A durometer in accordance with JIS K7311 (1995).

### Rebound Resilience

The rebound resilience of the thermoplastic polyurethane resin obtained was measured at 25° C. in accordance with JIS K7311 (1995).

TABLE 1

| | | | Production | Production | Production |
|---|---|---|---|---|---|
| | | | Example 1 | Example 2 | Example 3 |
| Thermoplastic polyurethane resin | | | TPU1 | TPU2 | TPU3 |
| Formulation | Polyether-based | Polytetramethylene | 69.1 | | |
| (mass parts) | polyol | glycol 1 | | | |
| | | Polytetramethylene | | 63.2 | |
| | | glycol 2 | | | |
| | Polyester-based | Polyethylene/butylene | | | 68.4 |
| | polyol | adipate glycol | | | |
| | Chain extender | 1,4-Butanediol | 5.8 | 5.3 | 6.0 |
| | Polyisocyanate | 4,4′-Diphenylmethane | 25.1 | 31.5 | 25.6 |
| | | diisocyanate | | | |

| | | | | |
|---|---|---|---|---|
| | Equivalent ratio ([NCO]/[OH]) of total | 1.01 | 1.03 | 1.02 |
| | moles of isocyanate groups to total | | | |
| | moles of active hydrogen groups in all | | | |
| | raw materials | | | |
| Evaluation | Shore A hardness | 85 | 85 | 85 |
| results | Rebound resilience [%] | 66 | 52 | 45 |

The following styrene-based elastomers were evaluated as follows. The respective test results are shown in Table 2.

Styrene-based elastomer 1: S.O.E. 51611 manufactured by Asahi Kasei Corporation (hydrogenated aromatic vinyl-based elastomer obtained by hydrogenating a polymer having polymer blocks composed of styrene at both ends and a random copolymer block in the middle, comprising a polymer block composed of styrene and a random copolymer block of styrene and butadiene; corresponds to the specified hydrogenated aromatic vinyl-based elastomer of the present application, styrene content: 60 mass %)

Styrene-based elastomer 2: Sibstar 102T manufactured by Kaneka (SIBS, corresponds to the specified hydrogenated aromatic vinyl-based elastomer of the present application, styrene content: 15 mass %)

Styrene-based elastomer 3: Sibstar 103T manufactured by Kaneka (SIBS, corresponds to the specified hydrogenated aromatic vinyl-based elastomer of the present application, styrene content: 30 mass %)

Styrene-based elastomer 4: Tuftech M1943 manufactured by Asahi Kasei Corporation (modified SEBS, styrene content: 20 mass %)

Styrene-based elastomer 5: Tuftech H1517 manufactured by Asahi Kasei Corporation (SEBS, styrene content: 43 mass %)

Styrene-based elastomer 6: Dynaron 1321P manufactured by JSR (HSBR, styrene content: 10 mass %)

Styrene-based elastomer 7: Cleiton D1161 manufactured by Cleiton Polymer Co. (SIS, styrene content: 15 mass %)

### Hardness and Rebound Resilience

The hardness and rebound resilience were measured in the same way as for the thermoplastic polyurethane resin.

TABLE 2

| | | Styrene-based elastomer | | | | | | |
|---|---|---|---|---|---|---|---|---|
| | | 1 | 2 | 3 | 4 | 5 | 6 | 7 |
| Evaluation | Shore A hardness | 82 | 47 | 68 | 71 | 95 | 42 | 40 |
| results | Rebound resilience [%] | 13 | 15 | 15 | 68 | 42 | 40 | 67 |
| | Shore A hardness × | 1066 | 705 | 1020 | 4828 | 3990 | 1680 | 2680 |
| | rebound resilience [%] | | | | | | | |

### Preparation of Thermoplastic Polyurethane Resin Composition

### Examples and Comparative Examples

After mixing by Henschel mixer according to the formulation shown in Table 3 and melt kneading by a short-shaft extruder 40 mm in diameter (set temperature: 150-250° C.), pellets were made, and a thermoplastic polyurethane resin composition was obtained.

2-mm-thick sheets were produced by injection molding (set temperature 150-250° C.) using the thermoplastic polyurethane resin compositions obtained, and the following evaluations were performed. The respective test results are shown in Table 3.

### Hardness and Rebound Resilience

The hardness and rebound resilience were measured in the same way as for the thermoplastic polyurethane resin.

### 100% Modulus, Tensile Strength, Elongation, Tear Strength, Taber Abrasion

The 100% modulus, tensile strength, elongation, tear strength, and Taber abrasion of the thermoplastic polyurethane resin compositions obtained were measured at 25° C. in accordance with JIS K7311 (1995).

### Injection Moldability

The following criteria were used to evaluate the resin curing status after demolding during injection molding.

Injection time: 20 sec, cooling time: 20 sec:

◯: Good demoldability, rapid curing, minimal tackiness, no deformation after demolding.

Δ: Moderate demoldability, somewhat-slow curing, evident tackiness, some deformation after demolding.

x: Difficult demolding, slow curing, strong tackiness, significant deformation after demolding.

TABLE 3

| | | Example 1 | Example 2 | Example 3 | Example 4 | Example 5 | Example 6 | Example 7 |
|---|---|---|---|---|---|---|---|---|
| Formulation | TPU1 | 85 | 70 | 55 | | | 85 | 85 |
| (mass parts) | TPU2 | | | | 85 | | | |
| | TPU3 | | | | | 85 | | |
| | Styrene-based elastomer 1 | 15 | 30 | 45 | 15 | 15 | | |
| | Styrene-based elastomer 2 | | | | | | 15 | |
| | Styrene-based elastomer 3 | | | | | | | 15 |
| | Styrene-based elastomer 4 | | | | | | | |
| | Styrene-based elastomer 5 | | | | | | | |
| | Styrene-based elastomer 6 | | | | | | | |
| | Styrene-based elastomer 7 | | | | | | | |
| Evaluation | Shore A hardness | 82 | 83 | 82 | 83 | 85 | 81 | 82 |
| results | Rebound resilience [%] | 50 | 40 | 30 | 38 | 36 | 54 | 47 |
| | 100% Modulus [MPa] | 4.6 | 4.1 | 3.2 | 4.1 | 4 | 3.8 | 3.8 |
| | Tensile strength [MPa] | 44 | 39 | 25 | 39 | 36 | 37 | 29 |
| | Elongation [%] | 700 | 690 | 750 | 640 | 550 | 700 | 700 |
| | Tear strength [kN/m] | 83 | 73 | 52 | 77 | 82 | 78 | 72 |
| | Taber abrasion [mg] | 114 | 223 | 390 | 171 | 192 | 183 | 110 |
| | Injection moldability | ∘ | ∘ | ∘ | ∘ | ∘ | ∘ | ∘ |
| | (solidification during | | | | | | | |
| | injection molding) | | | | | | | |

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Formulation | TPU1 | 100 | | 85 | 85 | 85 | 85 |
| (mass parts) | TPU2 | | 100 | | | | |
| | TPU3 | | | | | | |
| | Styrene-based elastomer 1 | | | | | | |
| | Styrene-based elastomer 2 | | | | | | |
| | Styrene-based elastomer 3 | | | | | | |
| | Styrene-based elastomer 4 | | | 15 | | | |
| | Styrene-based elastomer 5 | | | | 15 | | |
| | Styrene-based elastomer 6 | | | | | 15 | |
| | Styrene-based elastomer 7 | | | | | | 15 |
| Evaluation | Shore A hardness | 85 | 85 | 82 | 87 | 77 | 77 |
| results | Rebound resilience [%] | 66 | 52 | 66 | 56 | 61 | 61 |
| | 100% Modulus [MPa] | 5.4 | 5.7 | 4.7 | 4.5 | 3.8 | 3.8 |
| | Tensile strength [MPa] | 43 | 55 | 39 | 39 | 30 | 30 |
| | Elongation [%] | 580 | 550 | 590 | 650 | 580 | 580 |
| | Tear strength [kN/m] | 91 | 91 | 80 | 86 | 75 | 75 |
| | Taber abrasion [mg] | 38 | 27 | 176 | 273 | 550 | 312 |
| | Injection moldability | ∘ | x | ∘ | ∘ | ∘ | ∘ |
| | (solidification during | | | | | | |
| | injection molding) | | | | | | |

It was understood from Table 3 that the thermoplastic polyurethane resin compositions of the examples containing a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower display low hardness and low rebound resilience as well as good moldability. The thermoplastic polyurethane resin compositions of the examples had good moldability during injection molding while attaining a Shore A hardness of 85 or lower and a rebound resilience of 55% or lower. Also, the thermoplastic polyurethane resin compositions of the examples were understood to also have excellent wear resistance, and the Taber abrasion was confirmed to be 400 mg or lower.

As described above, it is usually difficult to achieve lower hardness and resilience while ensuring moldability in thermoplastic polyurethane resin compositions because low hardness, low rebound resilience, and the rate of solidification from the molten state are in a contradictory relationship, but the thermoplastic polyurethane resin composition of the present invention makes it possible to reduce the Shore A hardness to 90 or lower and the rebound resilience to 55% or lower, even a Shore A hardness of 85 or lower and rebound resilience of 55% or lower, while ensuring moldability. It was especially surprising to be able to reduce the Shore A hardness to 85 or lower and the rebound resilience to 55% or lower while ensuring moldability when a polyether-based thermoplastic polyurethane resin was used in particular.

1. A thermoplastic polyurethane resin composition comprising a thermoplastic polyurethane resin and a hydrogenated aromatic vinyl-based elastomer having a Shore A hardness of 90 or lower, a rebound resilience of 1-20%, and a product of the Shore A hardness and rebound resilience of 1300% or lower.

2. The thermoplastic polyurethane resin composition according to claim 1, wherein the hydrogenated aromatic vinyl-based elastomer is an elastomer obtained by hydrogenating a polymer comprising a polymer block made mainly of an aromatic vinyl compound and a random copolymer block of an aromatic vinyl compound and a conjugated diene compound.

3. The thermoplastic polyurethane resin composition according to claim 1, wherein the Shore A hardness is 90 or lower, the rebound resilience is 55% or lower, and a Taber abrasion is 400 mg or lower.

4. The thermoplastic polyurethane resin composition according to claim 1, wherein a mass ratio of the thermoplastic polyurethane resin and the hydrogenated aromatic vinyl-based elastomer (thermoplastic polyurethane resin/hydrogenated aromatic vinyl-based elastomer) is from 99/1 to 55/45.

5. The thermoplastic polyurethane resin composition according to claim 1, wherein thermoplastic polyurethane resin has a Shore A hardness of 90 or lower.

6. The thermoplastic polyurethane resin composition according to claim 1, wherein the thermoplastic polyurethane resin is a polyether-based thermoplastic polyurethane resin.

7. A molded article obtained by molding the resin composition according to claim 1.
